(19) United States
(12) Patent Application Publication
(10) Pub. No.: US 2007/0215039 A1
(43) Pub. Date: Sep. 20, 2007

(54) ROLL-TO-ROLL MANUFACTURING OF ELECTRONIC AND OPTICAL MATERIALS

(76) Inventors: Chuck Edwards, Rio Rancho, NM (US); Karel Vanheusden, Placitas, NM (US); Mark Kowalski, Albuquerque, NM (US); James Caruso, Albuquerque, NM (US)

Correspondence Address: Jaimes Sher, Esq;Cabot Corporation, 5401 Venice Avenue NE, Albuquerque, NM, 87113, US

(21) Appl. No.: 11/683,051

(22) Filed: Mar. 7, 2007

Related U.S. Application Data
(60) Provisional application No. 60/781,742, filed on Mar. 14, 2006.

(51) Int. Cl. B05C 11/00

(52) U.S. Cl. 118/46

(57) ABSTRACT

An apparatus and a method for manufacturing electrical and optical materials by ink-jet printing of electronic ink(s) onto a flexible substrate are provided. The apparatus includes a flexible substrate, a first roll and a second roll, a printing head for depositing a electronic ink onto the substrate according to a predetermined pattern, and a drying station for drying an amount of deposited electronic ink. Each roll is reversibly configured for feed or takeup of the substrate. When dry, the deposited electronic ink forms one of an electronic material, an optical material, a display, and a fuel cell electrode. The apparatus may also include a second printing head configured for depositing a second electronic ink onto the substrate after the first ink has dried. The apparatus may be configured to rewind the substrate prior to deposition of the second ink, or to reverse the feed/takeup direction of the rolls.

This application claims priority under 35 U.S.C. § 119(e) to U.S. Provisional Application No. 60/781,742, filed on Mar. 14, 2006, the entire contents of which are hereby incorporated by reference herein.

### BACKGROUND OF THE INVENTION

1. Field of the Invention

The present invention relates to ink-jet printing of electrical materials, optical materials, and energy materials used for fuel cells and batteries. More particularly, the invention relates to a method and apparatus for printing electrical and optical materials onto a substrate using a roll-to-roll printing device.

2. Related Art

The electronics, display and energy industries rely on the formation of coatings and patterns of conductive materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

Subtractive approaches and screen printing also generally require a significant degree of set-up and tooling in order to produce a desired patterned layer. By contrast, with digital printing (such as ink-jet printing), it is possible to print prototypes, short runs, and “just-in-time” runs without incurring significant set-up costs. In addition, a digital computer file controls these systems; therefore, no significant tooling changes are needed.

Ink-jet printing of conductors has been explored, but the approaches to date have been inadequate for producing well-defined features with good electrical properties, particularly at relatively low temperatures.

There exists a need for compositions for the fabrication of electrical components for use in electronics, displays, and other applications. Such components include, for example, conductors, insulators, resistors, dielectrics, inductors, optical materials, and battery and fuel cell materials. Further, there is a need for compositions that have low processing temperatures to allow deposition onto organic substrates and subsequent thermal treatment. It would also be advantageous if the compositions could be deposited with a fine feature size, such as not greater than about 100 μm, while still providing electronic features with adequate electrical and mechanical properties.

An advantageous metallic ink and its associated deposition technique for the fabrication of electrically electrical conductors would combine a number of attributes. The electrical conductor would have high conductivity, preferably close to that of the pure bulk metal. The processing temperature would be low enough to allow formation of conductors on a variety of organic substrates (polymers). The deposition technique would allow deposition onto surfaces that are non-planar (e.g., not flat). The conductor would also have good adhesion to the substrate. The composition would desirably be ink-jet printable, allowing the introduction of cost-effective material deposition for production of devices such as flat panel displays (PDP, AMLCD, OLED). The composition would desirably also be flexo, gravure, or offset printable, again enabling lower cost and higher yield production processes as compared to screen printing.

Further, there is a need for electronic circuit elements, particularly electrical conductors, and complete electronic circuits fabricated on inexpensive, thin and/or flexible substrates, such as paper, using high volume printing techniques such as roll-to-roll printing. Conventional printing of electronic elements is typically performed using a flat bed architecture. A flat bed architecture is required for rigid substrates, such as glass display or a printed circuit board, or for rigid electronic assemblies and solar cells. In addition flat bed architectures can be designed for high precision printing. However, flat bed architectures tend to be expensive, and can also be slow or cumbersome. Recent developments in organic thin film transistor (TFT) technology and organic light emitting device (OLED) technology have accelerated the need for complimentary circuit elements that can be written directly onto low cost substrates. Such elements include conductive interconnects, electrodes, conductive contacts and via fills. In addition, there is a need to account for operational and environmental conditions in the manufacture of such circuit elements.

Fuel cells are electrochemical devices, in which the energy from chemical reactions is converted to electricity. The electrochemical processes occur within a component of the fuel cell called Membrane Electrode Assembly (MEA). The MEA includes a Polymer Electrolyte Membrane (PEM) on both sides of which electrodes containing electrocatalysts are printed, forming a Catalyst Coated Membrane (CCM). Gas Diffusion Layers (GDLs) are attached to the CCM to complete the assembly of an MEA. The overall performance of the fuel cell MEAs is, to a significant degree, a combination of its intrinsic properties and the structure of the electrodes after inks have been formulated and deposited by a printing method. Currently, conventional printing methods, such as screen printing, decal transfer, and spray, are used for deposition of fuel cell electrodes onto the membrane. Ink jet printing offers significant advantages in the ability to print fuel cell electrodes with a high degree of uniformity and controlled thickness and porosity. Further, ink jet printing enables a minimal set up and high speed operation. Additional information relating to fuel cells is provided in U.S. Patent Application Publication No. US 2004/0038808 A1 and in U.S. Patent Application Publication No. US 2003/0130114 A1, the entire contents of each of which are incorporated herein by reference.

### SUMMARY OF THE INVENTION

In one aspect, the invention provides an ink-jet printing system. The system includes a first roll and a second roll; a first printing head; and a drying station. Each roll is reversibly configured for feed or takeup of a flexible substrate. The first printing head is configured for depositing a first electronic ink onto the substrate according to a predetermined pattern. The drying station is configured for drying an amount of deposited electronic ink prior to takeup of a corresponding portion of the substrate by the respective roll. The predetermined pattern is determined such that, when dry, the deposited electronic ink forms one of the group consisting of an electronic material, an optical material, a display, and a fuel cell electrode.

The ink-jet printing system may include a second printing head configured for depositing a second electronic ink onto the substrate according to the predetermined pattern. The drying station may be further configured for drying all of the deposited first electronic ink prior to the deposit of the second electronic ink. The predetermined pattern may be determined such that, for at least one portion of the substrate, the second electronic ink is deposited on top of the first electronic ink. When the first electronic ink has been deposited and dried, the feed and takeup rolls may be further configured to rewind the substrate prior to the second electronic ink being deposited. Alternatively, when the first electronic ink has been deposited and dried, a direction in which the flexible substrate is being fed and taken up by the first and second rolls may be reversed prior to the second electronic ink being deposited.

The ink-jet printing system may also include a second printing head configured for depositing a second electronic ink onto the substrate according to the predetermined pattern. The predetermined pattern may be determined such that the second electronic ink is deposited only at locations of the substrate at which none of the first electronic ink is to be deposited.

The first printing head may be further configured to deposit a second electronic ink onto the substrate according to the predetermined pattern after the first electronic has been deposited and dried. When the first electronic ink has been deposited and dried, the feed and takeup rolls may be further configured to rewind the substrate prior to the second electronic ink being deposited. Alternatively, when the first electronic ink has been deposited and dried, a direction in which the flexible substrate is being fed and taken up by the first and second rolls may be reversed prior to the second electronic ink being deposited.

The flexible substrate may be selected from the group consisting of polyimide, PEN, PET, a thin metal film, a thin plastic film, a polymer electrolyte membrane, a proton exchange membrane, a hydrocarbon membrane, coated paper, and uncoated paper. The ink-jet printing system may be configured to enable the flexible substrate to be inverted and reloaded onto the first and second rolls such that the printing head is configured to deposit the first electronic ink on an opposite surface of the substrate.

The drying station may be further configured for curing the amount of deposited electronic ink. Alternatively, the system may further comprise a curing station configured for curing the amount of deposited ink. The curing may be accomplished using at least one of the group consisting of a heating block, convective heating, infrared radiation, ultraviolet radiation, and microwave radiation. At least one of a security feature, a decorative feature, and an electrocatalyst may be printed onto the substrate.

In another aspect of the invention, a process for ink-jet printing an electro-optical material onto a flexible substrate is provided. The process includes the steps of: a) loading the flexible substrate onto a first roll and a second roll such that the first roll is configured to feed the substrate to the second roll across an ink depositing area; b) depositing a first electronic ink on a portion of the substrate according to a predetermined pattern; c) drying the deposited ink; d) using the first and second rolls to take up the portion of the substrate upon which ink has been deposited and dried and to feed another portion of the substrate onto the ink depositing area; and e) repeating steps b, c, and d until the predetermined pattern requires no additional deposits of the first electronic ink. The electro-optical material may be selected from the group consisting of an electronic material, an optical material, a display, and a fuel cell electrode. The flexible substrate may be selected from the group consisting of polyimide, PEN, PET, a thin metal film, a thin plastic film, a polymer electrolyte membrane, a proton exchange membrane, a hydrocarbon membrane, coated paper, and uncoated paper.

The process may further include the steps of: f) using the first and second rolls to rewind the substrate such that the first roll is again configured to feed the substrate to the second roll across the ink depositing area; g) depositing a second electronic ink on a portion of the substrate according to a predetermined pattern; h) drying the deposited ink; i) using the first and second rolls to take up the portion of the substrate upon which ink has been deposited and dried and to feed another portion of the substrate onto the ink depositing area; and j) repeating steps g, h, and i until the predetermined pattern requires no additional deposits of the second electronic ink.

Alternatively, the process may further include the steps of: f) reversing a direction of feed and takeup of the substrate by the first and second rolls such that the second roll is configured to feed the substrate to the first roll across the ink depositing area; g) depositing a second electronic ink on a portion of the substrate according to a predetermined pattern; h) drying the deposited ink; i) using the first and second rolls to take up the portion of the substrate upon which ink has been deposited and dried and to feed another portion of the substrate onto the ink depositing area; and j) repeating steps g, h, and i until the predetermined pattern requires no additional deposits of the second electronic ink.

In another alternative, the process may further include the steps of: f) inverting and reloading the substrate onto the first and second rolls such that the first roll is configured to feed the substrate to the second roll across the ink depositing area, and such that an opposite surface of the substrate is positioned to receive an ink deposit; g) depositing an electronic ink on a portion of the substrate according to a second predetermined pattern; h) drying the deposited ink; i) using the first and second rolls to take up the portion of the substrate upon which ink has been deposited and dried and to feed another portion of the substrate onto the ink depositing area; and j) repeating steps g, h, and i until the second predetermined pattern requires no additional deposits of the electronic ink deposited in step g.

The step of drying may include curing the deposited ink. Alternatively, the process may further include the step of curing the deposited ink. The step of curing may be performed by using at least one of a heating block, convective heating, infrared radiation, ultraviolet radiation, and microwave radiation. One of a security feature, a decorative feature, and an electrocatalyst may be printed onto the substrate.

In yet another aspect, the invention provides a process for inkjet printing an electro-optical material onto a flexible substrate. The process includes the steps of: a) loading the flexible substrate onto a first roll and a second roll such that the first roll is configured to feed the substrate to the second roll across an ink depositing area; b) depositing a first electronic ink on a first portion of the substrate according to a predetermined pattern; c) depositing a second electronic ink on the first portion of the substrate according to the predetermined pattern, wherein the predetermined pattern is determined such that the second electronic ink is deposited only at locations of the substrate at which none of the first electronic ink is to be deposited; d) drying the deposited inks; e) using the first and second rolls to take up the portion of the substrate upon which inks have been deposited and dried and to feed another portion of the substrate onto the ink depositing area; and f) repeating steps b, c, d and e until the predetermined pattern requires no additional deposits of the first and second electronic inks. The electro-optical material may be selected from the group consisting of an electronic material, an optical material, a display, and a fuel cell membrane. The flexible substrate may be selected from the group consisting of polyimide, PEN, PET, a thin metal film, a thin plastic film, a polymer electrolyte membrane, a proton exchange membrane, a hydrocarbon membrane, coated paper, and uncoated paper.

### BRIEF DESCRIPTION OF THE DRAWINGS

FIG. 1 illustrates an ink-jet printing apparatus having a single fixed printer head according to a preferred embodiment of the invention.

FIG. 2 illustrates an ink-jet printing apparatus having a moving print head assembly according to a preferred embodiment of the invention.

FIG. 3 illustrates a three-pass print-and-dry process using three electronic inks according to a preferred embodiment of the invention.

FIG. 4 illustrates a inversion of the substrate in order to enable ink-jet printing on both sides of a flexible substrate, according to preferred embodiment of the invention.

FIG. 5 illustrates a mechanical alignment technique for ensuring that the substrate is properly aligned for multiple pass printing, according to a preferred embodiment of the invention.

FIG. 6 illustrates an optical alignment technique for ensuring that the substrate is properly aligned for multiple pass printing, according to a preferred embodiment of the invention.

FIG. 7 illustrates an integration of a cutter with an ink-jet printing apparatus according to a preferred embodiment of the invention.

FIG. 8 shows a flow chart that illustrates a process of manufacturing electrical or optical materials using a roll-to-roll ink-jet printing apparatus according to a preferred embodiment of the invention.

### DETAILED DESCRIPTION OF THE INVENTION

In one aspect, the invention provides an ink-jet printing system. The system includes a first roll (also referred to as a supply roll) and, optionally, a second roll (also referred to as a takeup roll); a first printing head; and a drying station. For higher print speeds, an array of print heads may be used in place of a single print head for each individual material. The use of an array of print heads permits higher-speed printing by increasing the number of available jetting nozzles for each material. A one-roll system may be used for very short runs and prototypes when there is a desire to minimize waste. In a one-roll system the medium is pushed through the system without the need for a takeup roll, so that one or only a few prints can be produced on the edge of the medium without waste. An ink-jet system may be capable of both one-roll and two-roll operation.

A two-roll system may require that a sufficient amount of the substrate medium is used in order to reach through the printing system and the drying system. In a two-roll system, each roll is reversibly configured for feed or takeup of a flexible substrate. The first printing head is configured for depositing a first electronic ink onto the substrate according to a predetermined pattern. The drying station is configured for drying an amount of deposited electronic ink prior to takeup of a corresponding portion of the substrate by the respective roll. The predetermined pattern is determined such that, when dry, the deposited electronic ink forms one of the group consisting of an electronic material, an optical material, a display, and a fuel cell electrode.

In an aspect relating to printing fuel cell electrodes onto a polymer membrane, an ink jet printer may be capable of printing a first electrode layer onto one side of a substrate comprising a membrane. The printed first electrode layer may be dried, and then the membrane substrate may be inverted. A second electrode may be printed on the inverse side of the membrane substrate opposite the first electrode in a predetermined pattern. Preferably, care is taken to precisely match the positions of the print patterns for the respective electrode layers.

The ink-jet printing system may include multiple printing heads configured for depositing additional electronic inks onto the substrate according to the predetermined pattern. The drying station may be further configured for drying all of the deposited first electronic ink prior to the deposit of the second electronic ink. The predetermined pattern may be determined such that, for at least one portion of the substrate, the second electronic ink is deposited on top of the first electronic ink. When the first electronic ink has been deposited and dried, the feed and takeup rolls may be further configured to rewind the substrate prior to the second electronic ink being deposited. Alternatively, when the first electronic ink has been deposited and dried, a direction in which the flexible substrate is being fed and taken up by the first and second rolls may be reversed prior to the second electronic ink being deposited. If the additional electronic inks do not need to be printed over the other inks, they may be printed in the same printing pass and dried simultaneously to improve the efficiency of the printing process. For example, an insulating ink may be printed adjacent to the conductive ink in the same pass, so long as neither of the insulating ink and the conductive ink is required to be printed directly on top of the other.

The ink-jet printing system may also include additional printing heads configured for depositing additional electronic inks having different functionalities onto the substrate according to the predetermined pattern. The predetermined pattern may be determined such that the second electronic ink is deposited only at locations of the substrate at which none of the first electronic ink is to be deposited.

The first printing head may be further configured to deposit a second electronic ink onto the substrate according to the predetermined pattern after the first electronic has been deposited and dried. When the first electronic ink has been deposited and dried, the feed and takeup rolls may be further configured to rewind the substrate prior to the second electronic ink being deposited. Alternatively, when the first electronic ink has been deposited and dried, a direction in which the flexible substrate is being fed and taken up by the first and second rolls may be reversed prior to the second electronic ink being deposited.

A flushing or cleaning step is needed when changing between electronic inks on the same print head. To improve the efficiency of this system, an ink supply system may be used to provide multiple inks to the same print head. The ink being supplied may be switched either manually or electronically between printing passes.

The flexible substrate may be selected from the group consisting of polyimide, PEN, PET, various thin metal and plastic films, polymer electrolyte membrane, proton exchange membrane, hydrocarbon membrane, coated paper, and uncoated paper. The ink-jet printing system may be configured to enable the flexible substrate to be inverted and reloaded onto the first and second rolls such that the printing head is configured to deposit the electronic inks on an opposite surface of the substrate for two-sided circuits. When the substrate is inverted, a method of alignment between the top layer and the reverse layer is required to register the features on the two sides to each other.

The drying station may be further configured for curing the amount of deposited electronic ink. Alternatively, the system may further comprise a curing station configured for curing the amount of deposited ink. The curing may be accomplished using at least one of the group consisting of a heating block, convective heating, infrared radiation, ultraviolet radiation, and microwave radiation.

In another aspect of the invention, a process for ink-jet printing an electro-optical material onto a flexible substrate is provided. The process includes the steps of: a) loading the flexible substrate onto a first roll and a second roll such that the first roll is configured to feed the substrate to the second roll across an ink depositing area; b) depositing a first electronic ink on a portion of the substrate according to a predetermined pattern; c) drying the deposited ink; d) using the first and second rolls to take up the portion of the substrate upon which ink has been deposited and dried and to feed another portion of the substrate onto the ink depositing area; and e) repeating steps b, c, and d until the predetermined pattern requires no additional deposits of the first electronic ink. The electro-optical material may be selected from the group consisting of an electronic material, an optical material, a display, a battery, and a fuel cell electrode. The flexible substrate may be selected from the group consisting of polyimide, PEN, PET, various flexible metal and plastic films, membrane materials (e.g., polymer electrolyte membrane, proton exchange membrane, hydrocarbon membrane), coated paper, and uncoated paper.

Printing of these electronic or optical devices may be conducted on pre-printed or pre-processed substrates where other patterning techniques had already been used. For example, special inkjet optical features may be added to an existing graphics-printed substrate. Sensors or power supplies may be printed onto existing packaging, or RFID electronics may be printed onto a substrate that has already been printed with graphics. In these cases, the ink-jet printing system will optically align the previously printed features, so that it can place the new electronic or optical features in the proper location on the product.

The process may further include the steps of: f) using the first and second rolls to rewind the substrate such that the first roll is again configured to feed the substrate to the second roll across the ink depositing area; g) depositing an additional electronic ink on a portion of the substrate according to a predetermined pattern; h) drying the deposited ink; i) using the first and second rolls to take up the portion of the substrate upon which ink has been deposited and dried and to feed another portion of the substrate onto the ink depositing area; and j) repeating steps g, h, and i until the predetermined pattern requires no additional deposits of the second electronic ink. It is possible that the number of electronic or optical inks may be six or more different types of materials. Each may require a separate printing pass. Alternatively, in some cases, multiple materials may be printed within the same pass when they do not interfere with each other when wet.

Alternatively, the process may further include the steps of: f) reversing a direction of feed and takeup of the substrate by the first and second rolls such that the second roll is configured to feed the substrate to the first roll across the ink depositing area; g) depositing a second electronic ink on a portion of the substrate according to a predetermined pattern; h) drying the deposited ink; i) using the first and second rolls to take up the portion of the substrate upon which ink has been deposited and dried and to feed another portion of the substrate onto the ink depositing area; and j) repeating steps g, h, and i until the predetermined pattern requires no additional deposits of the second electronic ink.

In another alternative, the process may further include the steps of: f) inverting and reloading the substrate onto the first and second rolls such that the first roll is configured to feed the substrate to the second roll across the ink depositing area, and such that an opposite surface of the substrate is positioned to receive an ink deposit; g) depositing an electronic ink on a portion of the substrate according to a second predetermined pattern; h) drying the deposited ink; i) using the first and second rolls to take up the portion of the substrate upon which ink has been deposited and dried and to feed another portion of the substrate onto the ink depositing area; and j) repeating steps g, h, and i until the second predetermined pattern requires no additional deposits of the electronic ink deposited in step g.

The step of drying may include curing the deposited ink. Alternatively, the process may further include the step of curing the deposited ink. The step of curing may be performed by using at least one of a heating block, convective heating, infrared radiation, ultraviolet radiation, and microwave radiation. One of a security feature, a decorative feature, and an electrocatalyst may be printed onto the substrate.

In yet another aspect, the invention provides a process for ink-jet printing an electro-optical material onto a flexible substrate. The process includes the steps of: a) loading the flexible substrate onto a first roll and a second roll such that the first roll is configured to feed the substrate to the second roll across an ink depositing area; b) depositing a first electronic ink on a first portion of the substrate according to a predetermined pattern; c) depositing a second electronic ink on the first portion of the substrate according to the predetermined pattern, wherein the predetermined pattern is determined such that the second electronic ink is deposited only at locations of the substrate at which none of the first electronic ink is to be deposited; d) drying the deposited inks; e) using the first and second rolls to take up the portion of the substrate upon which inks have been deposited and dried and to feed another portion of the substrate onto the ink depositing area; and f) repeating steps b, c, d and e until the predetermined pattern requires no additional deposits of the first and second electronic inks. The electro-optical material may be selected from the group consisting of an electronic material, an optical material, a display, and a fuel cell electrode. The flexible substrate may be selected from the group consisting of polyimide, PEN, PET, various thin metal and plastic films, membrane materials, coated paper, and uncoated paper. In the display industry, the use of stainless steel “donor sheets” has been demonstrated for use in printing electronics onto a transferable substrate such that roll-to-roll manufacturing may be performed, and then the finished product may be transferred to the final substrate. Steel offers high curing temperature compatibility for manufacturing combined with roll-to-roll compatibility.

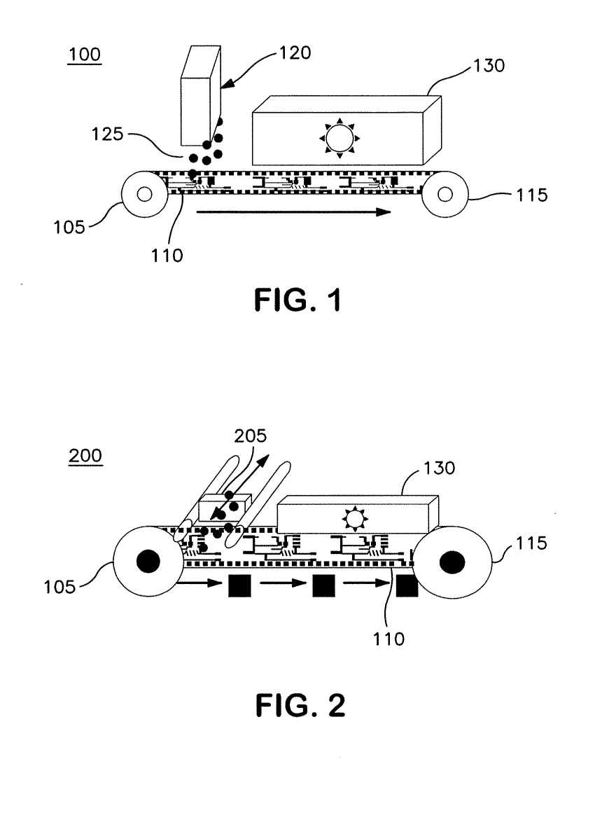

The present inventor has recognized that there is an industry need for a relatively efficient and inexpensive apparatus and methodology for manufacturing electrical and optical materials using inkjet printing processes. Referring to FIG. 1, an exemplary apparatus 100 according to a preferred embodiment of the invention includes a supply roll 105 for feeding a flexible substrate 110 to a second roll 115, which is used for takeup of the substrate 110. A fixed print head 120 is positioned relatively near to the feed roll 105. The fixed print head 120 is loaded with an electronic ink 125. Similar as with a standard ink-jet printer, the fixed print head 120 is configured to deposit the ink 125 onto the substrate 110 in a predetermined pattern. The predetermined pattern is selected such that, when dry, the electronic ink 125 will form an electrical material or an optical material, such as, for example, an electrical circuit element, a display, or a fuel cell electrode. In a preferred embodiment, the print width of the fixed print head is approximately in the range of 500 mm to 600 mm.

In an exemplary embodiment, the predetermined pattern may be selected such that, when dry, the electronic ink 125 will form a security feature. A security feature is a unique reflective feature that may enable a particular item to be uniquely identifiable or verifiable as being authentic. Further discussion relating to security features, and ink-jet printing of security features, may be found in the U.S. patent application entitled “Security Features, Their Use, and Processes for Making Them” which was filed on Jan. 13, 2006 and which has an Attorney Docket No. 2006A002, the entire contents of which are incorporated herein by reference. In another exemplary embodiment, the predetermined pattern may be selected such that, when dry, the electronic ink 125 will form a decorative feature. In yet another exemplary embodiment, the predetermined pattern may be selected such that, when dry, the electronic ink 125 will form an electrocatalyst.

The feed and takeup rolls 105 and 115 may be configured to continuously feed the substrate 110 across the fixed print head 120. The apparatus 100 also includes a drying module 130, which is positioned relatively near to the takeup roll 115. The drying module 130 dries the deposited ink 125 prior to takeup of the substrate. The drying module 130 may also be configured to cure the deposited ink 125. Alternatively, an additional curing module may be included in the apparatus 100 for curing the deposited ink. The curing module may use any of several known mechanisms for curing. Examples of curing mechanisms include: the use of a heating block; convective heating; infrared radiation; ultraviolet radiation; and microwave radiation.

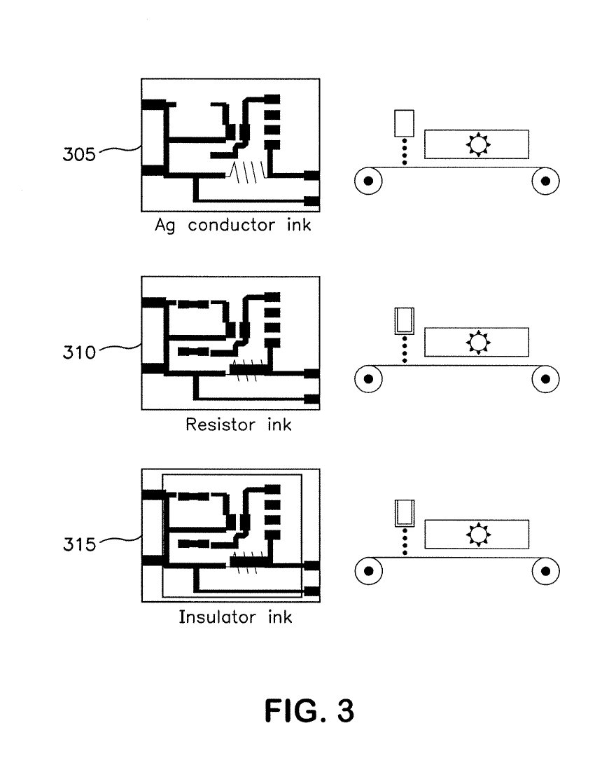

Referring to FIG. 2, a second exemplary roll-to-roll ink-jet printing apparatus 200 according to another preferred embodiment of the invention includes a moving print head assembly 205, which is loaded with the electronic ink 125. The apparatus 200 also includes a feed roll 105, a takeup roll 115, and a drying module 130.

Typically, apparatus 200 is configured to feed a portion of the substrate 110 into a position at which the ink 125 may be deposited, and then to stop the feed while the moving print head assembly 205 deposits the ink 125 onto that portion of the substrate. After the ink has been deposited, then the substrate is shifted so that the drying module 130 is positioned for drying the just-deposited ink 125, and the moving print head assembly 205 is then positioned to deposit more ink 125 onto a new portion of the substrate 125. The process of 1) shifting a portion of the substrate through the use of the feed and takeup rolls 105,115; 2) depositing ink 125 using the moving print head assembly 205; and 3) drying the just-deposited ink using the dryer 130 is repeated until the entire substrate 110 has been fed from the feed roll 105 to the takeup roll 115, or until all of the ink 125 required by the predetermined pattern has been deposited and dried.

In a preferred embodiment, the substrate 110 may be composed of polyimide, for example, a Kapton roll. In another preferred embodiment, the substrate 110 may be selected from the group consisting of PEN, PET, various thin metal and plastic films, membrane materials, coated paper, and uncoated paper. In general, the substrate 110 may be any suitable material which is sufficiently flexible to allow for the feed and takeup by a roll-to-roll printing apparatus according to the present invention, such as, for example, apparatus 100 or apparatus 200.

The apparatus 100 or 200 of the present invention may be used for depositing a plurality of electronic inks. For example, referring to FIG. 3, an exemplary electrical circuit may require the use of a conductive ink 305 (such as, e.g., a silver ink), a resistive ink 310, and an insulative ink 315. Each ink 305, 310, 315 is characterized by a specific electrical characteristic when cured or dried. In order that the inks 305, 310, 315 retain the appropriate electrical characteristics when dry, the first ink 305 should usually be completely deposited and completely dried prior to application of the second ink 310. Likewise, the second ink 310 should usually be completely deposited and dried prior to application of the third ink 315. By depositing and drying each ink separately, the likelihood that the inks will blend together is significantly reduced.

The ability to deposit a plurality of electronic inks may be manifested by either the use of multiple print heads; by multiple passes of the substrate, where the print head is loaded successively with the new ink on each pass of the substrate; or by a combination of the two. For example, referring again to FIG. 3, the conductive silver ink 305 may be deposited and dried in a first pass. Then, in preparation for a second pass, the flexible substrate may be completely rewound from the takeup roll to the feed roll. Alternatively, the direction of feed and takeup may be reversed. If the feed/takeup direction is reversed, then the placement of the print head and the drying module must also be reversed. Reversing the feed/takeup direction may alternatively be accomplished by swapping the positions of the feed and takeup rolls, so that the takeup roll will act as the feed roll, and vice versa. Then, in a second pass, the resistive ink 310 is loaded into the print head, and then the ink may be deposited and dried. Following the second pass, the flexible substrate may be rewound again, or the feed/takeup direction may be reversed again. Finally, in a third pass, the insulative ink 315 is loaded into the print head, and then the ink may be deposited and dried.

If multiple print heads are to be used to simultaneously deposit two or more different electronic inks onto the substrate in the same pass, care must be taken to ensure that the locations onto which the inks are being deposited do not overlap, because if they do overlap, then the inks will be blended in a “wet-on-wet” manner. This is not desirable, because when blended, the electrical characteristics of electronic inks may be modified in unpredictable ways. So long as the deposit locations do not overlap, the use of multiple print heads to simultaneously deposit two or more different inks will increase production efficiency.

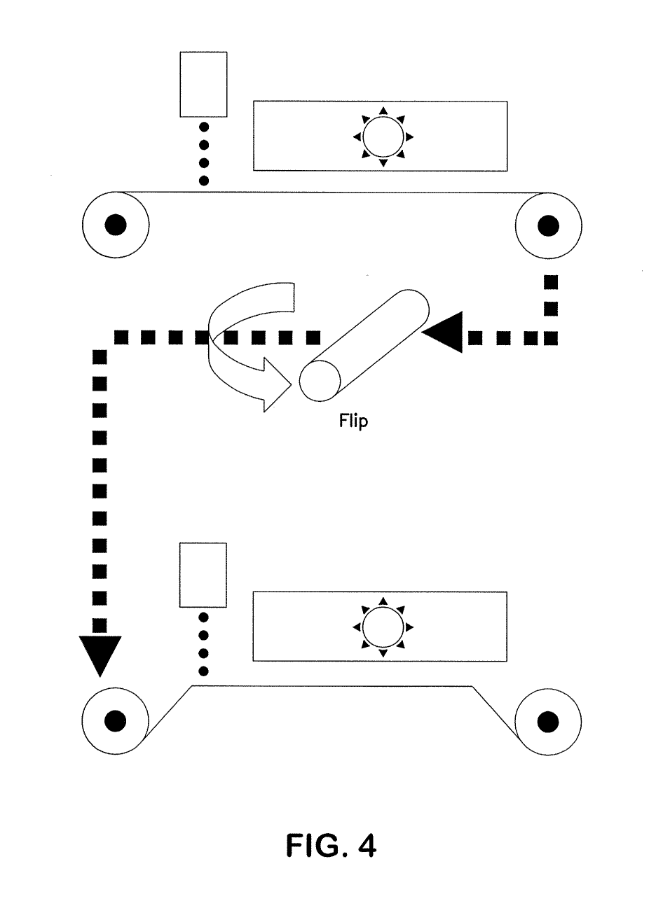

Referring to FIG. 4, in some instances, it may be desirable to invert the flexible substrate 110 so that ink-jet printing of electrical or optical materials may be performed using both sides of the substrate. To accomplish this, typically, a first pass (or passes) will occur as described above, and then the takeup roll 115 will be removed and inverted, or “flipped”, and placed in the feed position. The feed roll 105 will be placed in the takeup position. Because the roll 115 has been flipped, the substrate will now be fed so that the opposite surface is positioned for receiving deposits of electronic ink on the next pass.

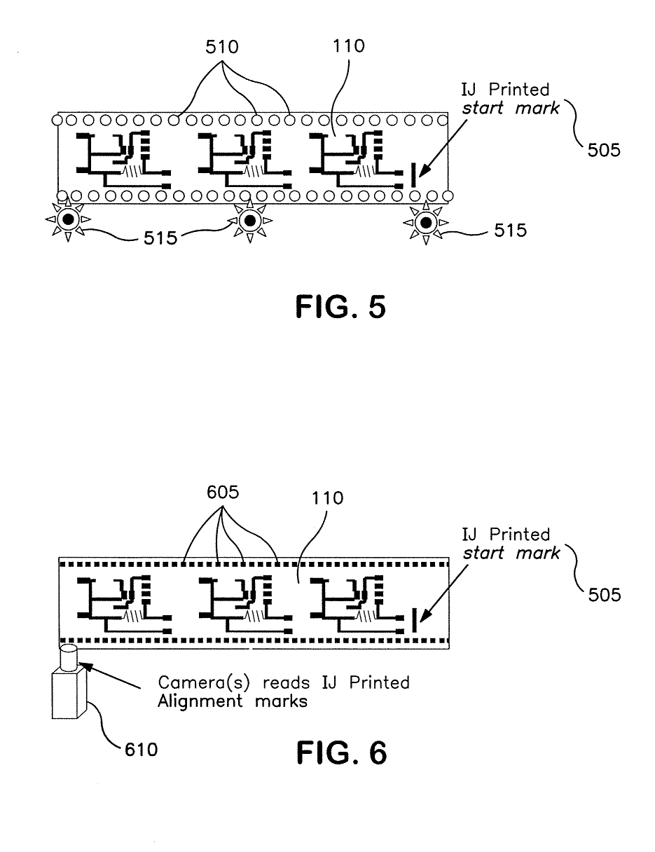

An important consideration for performing multiple passes is to properly align the substrate. If the substrate is not properly aligned, then it may migrate, or “drift”, thus causing deposits of ink on subsequent passes to be located at incorrect locations on the substrate, which in turn will likely cause faulty construction of the desired electrical or optical material. Referring to FIG. 5, one preferred method of ensuring proper alignment is a mechanical alignment. In a mechanical alignment, a series of holes 510, conventionally referred to as “tractor” holes, are set on both sides of the substrate 110. In addition, a start mark 505 is printed near the beginning of the substrate. The feed mechanism includes a series of “tractor wheels” 515 that are compatible with the tractor holes 505. By mechanically feeding the substrate 110 such that the tractor wheels 515 continuously engage the tractor holes 510, the substrate alignment is maintained.

Referring to FIG. 6, a more preferred method of alignment involves the use of a camera 610 to optically align the substrate. In place of the tractor holes, a series of marks 605 is printed on each side of the substrate 110. The camera 610 detects the marks 605 to maintain the alignment. The start mark 505 is also included for the optical alignment. The optical alignment method is preferred over the mechanical alignment method because it is more accurate and less prone to cause physical damage to the substrate.

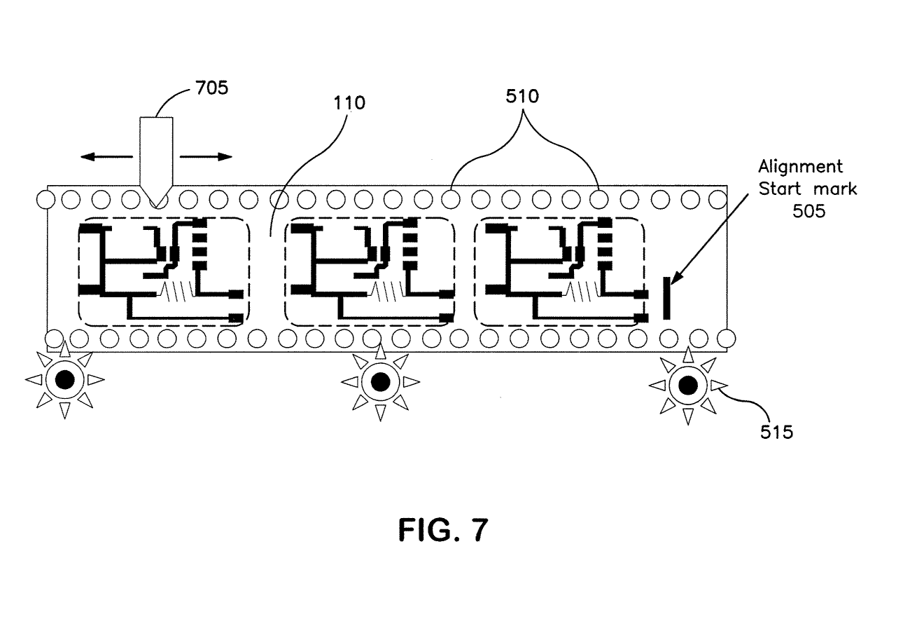

A cutting mechanism may also be integrated with the alignment system. Cutting is important because in many applications, a single roll of substrate will include a large number of separate electrical or optical materials. Therefore, after the ink-jet printing and drying of the inks, the substrate must be cut at precise locations between adjacent finished materials. The use of an integrated cutting mechanism enables efficiency and accuracy in performing the cutting function. Referring to FIG. 7, a cutter 705 may be integrated with the alignment system. In this manner, the cutter 705 may be configured or programmed to perform a cut at a specific location, which is determined using the alignment system such as, for example, either the mechanical alignment system of FIG. 5 or the optical alignment system of FIG. 6.

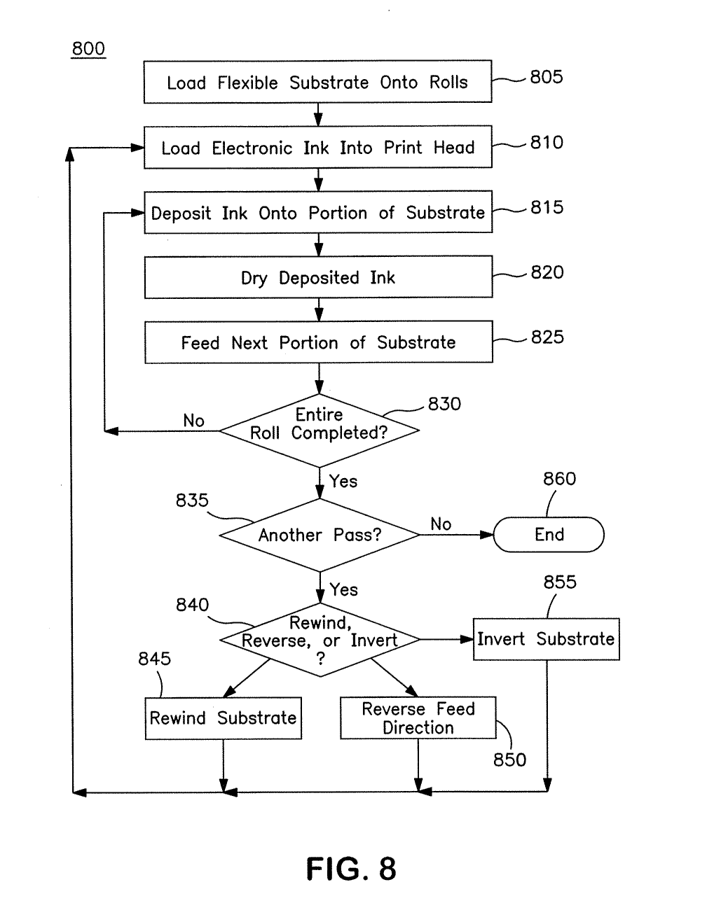

Referring to FIG. 8, a flowchart 800 is provided which illustrates a process of manufacturing electrical or optical materials using a roll-to-roll apparatus and an ink-jet printing system according to a preferred embodiment of the invention. The first step 805 is to load the flexible substrate onto a first roll and a second roll such that the first roll is configured to feed the substrate to the second roll across an ink depositing area. At step 810, a first electronic ink is loaded into the print head. Then, at step 815, the print head deposits the first electronic ink on a portion of the substrate according to a predetermined pattern. The predetermined pattern is determined such that, when dry, the deposited and cured ink(s) constitute a desired electrical or optical material, as described above. At step 820, the deposited ink is dried, prior to takeup of the corresponding portion of the flexible substrate by the takeup roll. At step 825, this portion of the substrate is taken up and another portion of the substrate is fed into a position at which ink may be deposited onto the substrate by the print head.

Notably, the process defined by steps 815, 820, and 825 may be performed continuously, i.e., a continuous feed of the flexible substrate from the feed roll to the takeup roll may be occurring. However, even when a continuous feed is performed, steps 815, 820, and 825 are performed in that order; i.e., the ink is deposited, then dried, and then the corresponding portion of the substrate is taken up by the takeup roll. These three steps are repeated until the entire roll has been completed, or until the predetermined pattern has been completed, as determined at step 830.

Once the predetermined pattern is completed for a first ink, a determination is made at step 835 as to whether a second ink is to be added on a second pass. If not, the process is completed (step 860). If a second ink is to be added, then either the roll is rewound, at steps 840 and 845, or the feed/takeup direction is effectively reversed as described above, at steps 840 and 850. Once the substrate is ready to be fed across the print head and the drying module again, then steps 810, 815, 820, 825, and 830 are repeated for the second ink.

The entire process may be repeated as many times as necessary to accommodate as many inks or as many passes as are required. Further, at steps 840 and 855, the substrate may be inverted to enable ink-jet printing on both sides of the substrate, as previously described. After all of the necessary inks have been properly deposited and dried on the entire roll of flexible substrate, the process is completed at step 860.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An ink-jet printing system, comprising:
a first roll and a second roll, each roll being reversibly configured for feed or takeup of a flexible substrate;
a first printing head configured for depositing a first electronic ink onto the substrate according to a predetermined pattern; and
a drying station configured for drying an amount of deposited electronic ink prior to takeup of a corresponding portion of the substrate by the respective roll,
wherein the predetermined pattern is determined such that, when dry, the deposited electronic ink forms one of the group consisting of an electronic material, an optical material, a display, and a fuel cell electrode.

2. The inkjet printing system of claim 1, further comprising a second printing head configured for depositing a second electronic ink onto the substrate according to the predetermined pattern,
wherein the drying station is further configured for drying all of the deposited first electronic ink prior to the deposit of the second electronic ink.

3. The ink-jet printing system of claim 2, wherein the predetermined pattern is determined such that, for at least one portion of the substrate, the second electronic ink is deposited on top of the first electronic ink.

4. The ink-jet printing system of claim 3, wherein when the first electronic ink has been deposited and dried, the feed and takeup rolls are further configured to rewind the substrate prior to the second electronic ink being deposited.

5. The ink-jet printing system of claim 3, wherein when the first electronic ink has been deposited and dried, a direction in which the flexible substrate is being fed and taken up by the first and second rolls is reversed prior to the second electronic ink being deposited.

6. The ink-jet printing system of claim 1, further comprising a second printing head configured for depositing a second electronic ink onto the substrate according to the predetermined pattern,
wherein the predetermined pattern is determined such that the second electronic ink is deposited only at locations of the substrate at which none of the first electronic ink is to be deposited.

7. The ink-jet printing system of claim 1, wherein the first printing head is further configured to deposit a second electronic ink onto the substrate according to the predetermined pattern after the first electronic has been deposited and dried.

8. The ink-jet printing system of claim 7, wherein when the first electronic ink has been deposited and dried, the feed and takeup rolls are further configured to rewind the substrate prior to the second electronic ink being deposited.

9. The ink-jet printing system of claim 7, wherein when the first electronic ink has been deposited and dried, a direction in which the flexible substrate is being fed and taken up by the first and second rolls is reversed prior to the second electronic ink being deposited.

10. The ink-jet printing system of claim 1, wherein the flexible substrate is selected from the group consisting of polyimide, PEN, PET, a thin metal film, a thin plastic film, a polymer electrolyte membrane, a proton exchange membrane, a hydrocarbon membrane, coated paper, and uncoated paper.

11. The ink-jet printing system of claim 1, the system being configured to enable the flexible substrate to be inverted and reloaded onto the first and second rolls such that the printing head is configured to deposit the first electronic ink on an opposite surface of the substrate.

12. The ink-jet printing system of claim 1, wherein the drying station is further configured for curing the amount of deposited electronic ink.

13. The ink-jet printing system of claim 1, the system further comprising a curing station configured for curing the amount of deposited electronic ink using at least one of the group consisting of a heating block, convective heating, infrared radiation, ultraviolet radiation, and microwave radiation.

14. The ink-jet printing system of claim 1, wherein at least one of the group consisting of a security feature, a decorative feature, and an electrocatalyst is printed onto the substrate.

15. A process for ink-jet printing an electro-optical material onto a flexible substrate, the process comprising the steps of:
a) loading the flexible substrate onto a first roll and a second roll such that the first roll is configured to feed the substrate to the second roll across an ink depositing area;
b) depositing a first electronic ink on a portion of the substrate according to a predetermined pattern;
c) drying the deposited ink;
d) using the first and second rolls to take up the portion of the substrate upon which ink has been deposited and dried and to feed another portion of the substrate onto the ink depositing area; and
e) repeating steps b, c, and d until the predetermined pattern requires no additional deposits of the first electronic ink.

16. The process of claim 15, wherein the electro-optical material is selected from the group consisting of an electronic material, an optical material, a display, and a fuel cell electrode.

17. The process of claim 15, further comprising the steps of:
f) using the first and second rolls to rewind the substrate such that the first roll is again configured to feed the substrate to the second roll across the ink depositing area;
g) depositing a second electronic ink on a portion of the substrate according to a predetermined pattern;
h) drying the deposited ink;
i) using the first and second rolls to take up the portion of the substrate upon which ink has been deposited and dried and to feed another portion of the substrate onto the ink depositing area; and
j) repeating steps g, h, and i until the predetermined pattern requires no additional deposits of the second electronic ink.

18. The process of claim 15, further comprising the steps of:
f) reversing a direction of feed and takeup of the substrate by the first and second rolls such that the second roll is configured to feed the substrate to the first roll across the ink depositing area;
g) depositing a second electronic ink on a portion of the substrate according to a predetermined pattern;
h) drying the deposited ink;
i) using the first and second rolls to take up the portion of the substrate upon which ink has been deposited and dried and to feed another portion of the substrate onto the ink depositing area; and
j) repeating steps g, h, and i until the predetermined pattern requires no additional deposits of the second electronic ink.

19. The process of claim 15, further comprising the steps of:
f) inverting and reloading the substrate onto the first and second rolls such that the first roll is configured to feed the substrate to the second roll across the ink depositing area, and such that an opposite surface of the substrate is positioned to receive an ink deposit;
g) depositing an electronic ink on a portion of the substrate according to a second predetermined pattern;
h) drying the deposited ink;
i) using the first and second rolls to take up the portion of the substrate upon which ink has been deposited and dried and to feed another portion of the substrate onto the ink depositing area; and
j) repeating steps g, h, and i until the second predetermined pattern requires no additional deposits of the electronic ink deposited in step g.

20. The process of claim 15, wherein the flexible substrate is selected from the group consisting of polyimide, PEN, PET, a thin metal film, a thin plastic film, a polymer electrolyte membrane, a proton exchange membrane, a hydrocarbon membrane, coated paper, and uncoated paper.

21. The process of claim 15, wherein the step of drying includes curing the deposited ink.

22. The process of claim 15, the process further comprising the step of curing the deposited ink using at least one of the group consisting of a heating block, convective heating, infrared radiation, ultraviolet radiation, and microwave radiation.

23. The process of claim 15, wherein at least one of the group consisting of a security feature, a decorative feature, and an electrocatalyst is printed onto the substrate.

24. A process for inkjet printing an electro-optical material onto a flexible substrate, the process comprising the steps of:
a) loading the flexible substrate onto a first roll and a second roll such that the first roll is configured to feed the substrate to the second roll across an ink depositing area;
b) depositing a first electronic ink on a first portion of the substrate according to a predetermined pattern;
c) depositing a second electronic ink on the first portion of the substrate according to the predetermined pattern, wherein the predetermined pattern is determined such that the second electronic ink is deposited only at locations of the substrate at which none of the first electronic ink is to be deposited;
d) drying the deposited inks;
e) using the first and second rolls to take up the portion of the substrate upon which inks have been deposited and dried and to feed another portion of the substrate onto the ink depositing area; and
f) repeating steps b, c, d and e until the predetermined pattern requires no additional deposits of the first and second electronic inks.

25. The process of claim 24, wherein the electro-optical material is selected from the group consisting of an electronic material, an optical material, a display, and a fuel cell electrode.

26. The process of claim 24, wherein the flexible substrate is selected from the group consisting of polyimide, PEN, PET, a thin metal film, a thin plastic film, a polymer electrolyte membrane, a proton exchange membrane, a hydrocarbon membrane, coated paper, and uncoated paper.
